(19) United States
(12) Patent Application Publication
(10) Pub. No.: US 2014/0340717 A1
(43) Pub. Date: Nov. 20, 2014

(54) REAL-TIME SECURE DIGITAL FACSIMILE IMPLEMENTATION USING CLOUD SERVICES

(71) Applicant: CONEXANT SYSTEMS, INC., Irvine, CA (US)

(72) Inventor: Somasundaram Meiyappan, Singapore (SG)

(73) Assignee: CONEXANT SYSTEMS, INC., Irvine, CA (US)

(21) Appl. No.: 14/282,896

(22) Filed: May 20, 2014

Related U.S. Application Data
(60) Provisional application No. 61/825,452, filed on May 20, 2013.

(51) Int. Cl. H04N 1/21; H04N 1/32

(52) U.S. Cl. CPC H04N 1/2166; H04N 1/32
USPC 358/400

(57) ABSTRACT

A system for cloud-based facsimile services comprising a cloud facsimile sending device configured to be coupled to a network, to generate image data of a document and to transmit the image data over the network. A cloud facsimile receiving device configured to be coupled to the network, to receive the image data and to generate image status data over the network. A cloud facsimile service configured to be coupled to the network and to receive the image data from the cloud facsimile sending device, to process the image data as a function sender data and recipient data, to transmit the image data to the cloud facsimile receiving device, to receive the image status data from the cloud facsimile receiving device and to transmit the image status data to the cloud facsimile sending device. A facsimile proxy service coupled to the network and to a public switched telephone network (PSTN) and configured to receive the image data from the cloud facsimile service and to transmit the image data over the PSTN to a facsimile device.

### RELATED APPLICATIONS

The present application claims priority to U.S. Provisional Patent Application No. 61/825,452, filed May 20, 2013, which is hereby incorporated by reference for all purposes as if set forth herein in its entirety.

### TECHNICAL FIELD

The present disclosure relates to facsimile systems, and more specifically to a system and method for real-time secure digital facsimile transmission that can utilize cloud printing services.

### BACKGROUND OF THE INVENTION

Facsimile (or fax) services are used in conjunction with the public switched telephone network (PSTN). Although email is used in place of fax services, some businesses or institutions still require transmission by fax, which requires many other institutions to maintain fax equipment.

### SUMMARY OF THE INVENTION

A system for cloud-based facsimile services comprising a cloud facsimile sending device configured to be coupled to a network, to generate image data of a document and to transmit the image data over the network. A cloud facsimile receiving device configured to be coupled to the network, to receive the image data and to generate image status data over the network. A cloud facsimile service configured to be coupled to the network and to receive the image data from the cloud facsimile sending device, to process the image data as a function sender data and recipient data, to transmit the image data to the cloud facsimile receiving device, to receive the image status data from the cloud facsimile receiving device and to transmit the image status data to the cloud facsimile sending device. A facsimile proxy service coupled to the network and to a public switched telephone network (PSTN) and configured to receive the image data from the cloud facsimile service and to transmit the image data over the PSTN to a facsimile device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for providing a cloud facsimile service in accordance with an exemplary embodiment of the present disclosure;

FIG. 2 is a diagram of a system for access control to a cloud facsimile service in accordance with exemplary embodiment of the present disclosure;

FIG. 3 is a diagram of a system for providing cloud-based facsimile service transmit controls, in accordance with an exemplary embodiment of the present disclosure;

FIG. 4 is a diagram of a system for generating cloud facsimile receiver controls in accordance with an exemplary embodiment of the present disclosure; and

FIG. 5 is a diagram of an algorithm for configuring cloud-based facsimile service access, access to facsimile transmitters, and access to facsimile receivers in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

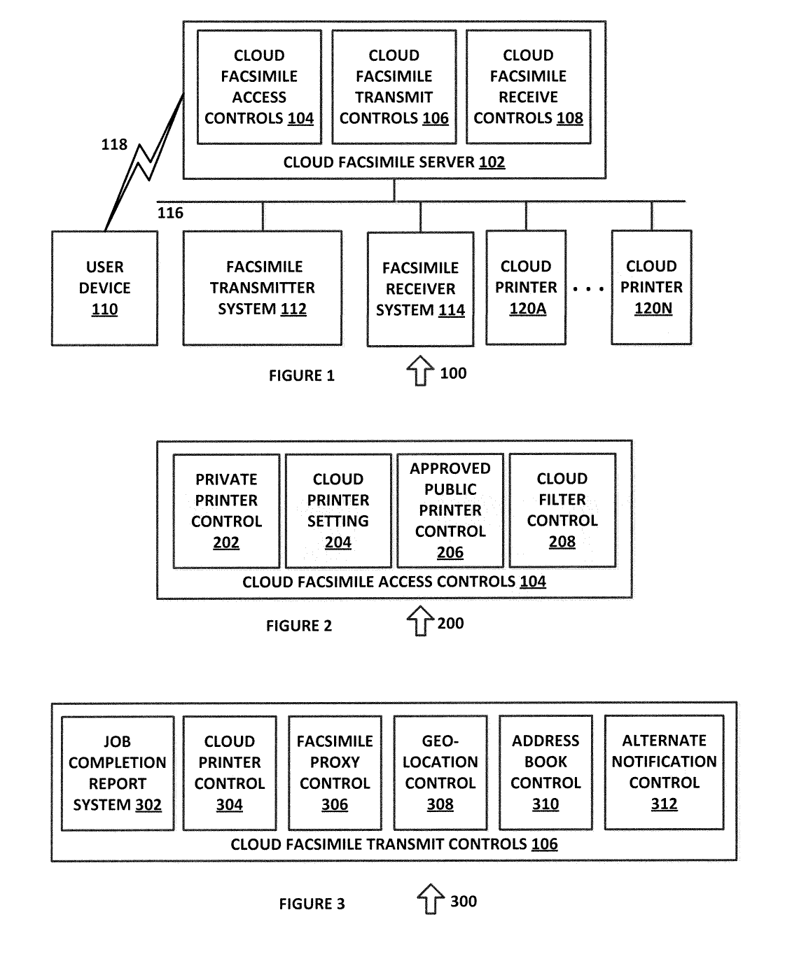

FIG. 1 is a diagram of a system 100 for providing a cloud facsimile service in accordance with an exemplary embodiment of the present disclosure. System 100 includes cloud facsimile server 102, cloud facsimile access controls 104, cloud facsimile transmit controls 106 and cloud facsimile receive controls 108, each of which can each be implemented in hardware or a suitable combination of hardware and software, and can be one or more software systems operating on a suitable processor.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as keyboards or mice, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Cloud facsimile server 102 receives documents that are sent by facsimile transmitter system 112 and provides the documents to facsimile receiver system 114, such as by using public switched telephone network (PSTN) facsimile transmission and reception protocol, by using an Internet Protocol (IP) facsimile transmission and reception process or in other suitable manners. Cloud facsimile server 102 can receive and transmit facsimiles transmissions (also known as “faxes”) between devices in accordance with different protocols, so as to allow any suitable device which can communicate over wireline communications medium 116, wireless communications medium 118 or other suitable communications media to send or receive facsimile transmissions to any other suitable device. The widespread use of the PSTN fax protocol and the lack of a universally acceptable IP-based fax solution/service have slowed advances in this area, as well as the acceptance of the limited advances that have been made. The present disclosure presents a real-time and secure digital facsimile system that makes use of cloud printing solutions, such as Google Cloud Printing, to allow devices to send and receive faxes. Facsimile receiver system 114 can have an associated printer, can be a PSTN fax machine, can have associated cloud printers 120A through 120N, or other suitable printers can also or alternatively be used.

Sending a fax can involve a real-time transmission of image data from a first device that is configured to transmit data using a fax protocol to a second device that is configured to receive data using the fax protocol. Fax transmission is not inherently secure from interception by third parties that can intercept the fax signals transmitted over the PSTN, such as by placing a tap on the PSTN signal lines. There have also been other issues, such as “spam” or undesired faxes, that are problematic but which are not related to security. For example, a user with a personal fax machine may receive a number of undesired faxes every day, and might be unable to prevent their reception and the associated waste of resources such as paper and ink without turning the fax machine off completely.

Cloud printing uses a network such as the Internet to connect devices with printers, and many multi-function peripheral (MFP) manufacturers have implemented cloud printing services to improve the ability to print from a device that is coupled to the network. The present disclosure provides a cloud printing-based implementation of real-time digital fax transmission.

MFP printers can be connected to a cloud printing service, such that they can accept print jobs and print from that cloud printing service. The cloud printing service typically communicates with the printer using secured data transmission protocol, such as HTTPS or other suitable protocols.

A print client application that is used to submit a print job to a cloud-connected MFP printer can also require authentication and authorization for a program to access and print to devices on the service account holder's behalf. In this disclosure, an MFP, scanner or other imaging device can be used as the client that submits a print job to one or more cloud MFP printers that are associated with the service account. Such cloud-enabled scanners, MFPs or devices can thus send print jobs/image data to other cloud-enabled MFPs, printers or devices. The user in the scanning device (sender), after authenticating into the cloud printing service as a print client, selects the recipient (printing device) and initiates for some pages to be scanned by the scanning device and sent to the selected printing device. The recipient accepts the job submitted into its Cloud Printing queue and prints the job. This capability, coupled with real-time notifications to the printing device on arrival of a new job and real-time notification on the status of a submitted job to the scanning device, provides the basic functionality of a Cloud Printing-based real-time digital facsimile solution.

Cloud facsimile access controls 104 include one or more objects that are used to generate a user interface control on a suitable user interface device, such as a touch screen controller, using a mouse and associated display, or in other suitable manners. In this exemplary embodiment, the objects can have state and associated graphical components, text components and functional components that cause a user interface control to be generate that allows a user to select one or more access controls for cloud facsimile server 102, such as to configure users, printers, defaults or other suitable access controls, as described in greater detail herein.

Cloud facsimile transmit controls 106 include one or more objects that are used to generate a user interface control on a suitable user interface device, such as a touch screen controller, using a mouse and associated display, or in other suitable manners. In this exemplary embodiment, the objects can have state and associated graphical components, text components and functional components that cause a user interface control to be generated that allows a user to select one or more transmit controls for cloud facsimile server 102, such as to select print settings, to request job completion notification, to use address book features or other suitable access controls, as described in greater detail herein.

Cloud facsimile receive controls 108 include one or more objects that are used to generate a user interface control on a suitable user interface device, such as a touch screen controller, using a mouse and associated display, or in other suitable manners. In this exemplary embodiment, the objects can have state and associated graphical components, text components and functional components that cause a user interface control to be generated that allows a user to select one or more receive controls for cloud facsimile server 102, such as to receive queued faxes, to apply filters or other suitable receive controls, as described in greater detail herein.

In general, system 100 can include these components:

1. Device(s) that scan pages and send to the cloud facsimile server 102;
2. Device(s) that accept print jobs from the cloud facsimile server 102 and print them; and
3. Cloud facsimile server 102 that is configured to provide:

a. Notification of new jobs submitted to a printer

b. Notification of job status changes to the sender/submitter

c. Discovery of printers

d. Other suitable functionality

In one exemplary embodiment, cloud printer-based devices can be capable of receiving and printing digital facsimile pages, so that facsimile jobs can be the same as jobs submitted to a cloud printing queue. The sender's information (which can correlate to a print job submitter), such as the cloud print service account information, can be embedded in the job ticket so that the recipient can identify the sender. The receiving cloud printer periodically updates the status of the received print job, as supported by cloud facsimile server 102. The receiver can update the status of the job as it completes printing of every page and eventually the job. Job status can also be updated when there are errors when printing the job. Cloud facsimile server 102 can relay these job status changes to all interested clients, including the sending device.

Cloud facsimile server 102 can also work with a remote device that still uses traditional fax technology, such as over a PSTN or voice over Internet Protocol (VoIP) connection. In one embodiment, a service provider (which may be the cloud facsimile server 102 or a third party service provider) can host this virtual cloud printer that acts a fax proxy. The fax proxy can provide one or more dedicated phone numbers for a receiver that has signed up with cloud fax service in one or more countries/regions. A traditional fax machine can then send a job to one of these phone numbers. The fax proxy can first decide whether to accept the fax job or not, such as based on a Caller ID filter that is setup by the fax proxy account user. The incoming fax job can be converted into a cloud print job by the proxy and forwarded to one of the cloud printers that the administrator has setup for their fax proxy account. In this exemplary workflow, the fax proxy behaves in the same manner as a cloud facsimile server 102 client and submits a print job to a cloud printer. If more than one cloud printer is setup for the fax proxy account, then the fax proxy can choose the printer to which the incoming fax is forwarded to, such as based on criterion that can include:

1. A fax proxy account user's ordered preference,
2. The first printer in a user-provided ordered list that is powered-on, assuming that the proxy will be able to find out which of these printers are actually powered-on and connected to the cloud print service, or
3. Load balancing between these printers.

The fax proxy can submit the received fax job to the chosen cloud printer after converting the format and setting the print settings, based on the print capabilities that have been shared with the fax proxy, the role assigned to that printer, and based on other suitable variables.

For the sender of a fax over the PSTN, the fax job can be deemed to be complete when the job has been successfully transferred to the fax proxy, so as to avoid keeping the sending fax machine online until the user receives the transmitted fax, such as by viewing the fax. In another exemplary embodiment, a first indicator can be generated that shows that the fax was received by cloud facsimile server 102, and a confirmation fax can be transmitted to the sender when the user views the original fax job, or other suitable processes can also or alternatively be used.

Cloud facsimile server 102 can utilize access control mechanisms and print restrictions to protect resources from spamming or other abuses. The Cloud Printing system can also utilize a special directory listing capability that can allow businesses to be discovered and also protected from spamming or abuses.

Cloud printers 120A through 120N can be identified using a unique identifier or in other suitable manners. Typically, there are two kinds of cloud printers 120A through 120N:

1. Private Printers: Printers that can be used either by the owner or by users with whom the printers have been explicitly shared. Information on users that have access to the printer can be maintained in a “white list” or other suitable locations.
2. Public Printers: Printers that can be accessed by any user that has the unique ID of the printer.

In this disclosure, a public printer can allow any user to print to it, a “black list” can be defined for the public printer by an administrator to prevent known spammers from printing to it, or other suitable configurations can also or alternatively be used. The black list can identify a unique cloud service account that should be prevented from printing to the printer, a regular expression or rules that can be used to prevent predetermined users from accessing the printer, or other suitable data. In one exemplary embodiment, a rule for a black list can include “service_account.creation_time is less than 1 day,” which can be used to prevent any users from using the printer within one day of creating their account. This exemplary rule provides some protection against users who modify device statistics in order to circumvent black lists. Such rule-based black lists for public cloud printers can be used to provide a defense against spam even when the printer is shared publicly with users unknown to the printer administrator.

Cloud facsimile server 102 allows a number of different role to be assigned to a given user, as a function of a user identifier, for one or more printers or in other suitable manners:

1. Owner: The service account that was used to register the printer with cloud facsimile server 102. Transfer of ownership can be allowed such that the account that is listed as the owner can be changed to another account.

2. Administrator: The service account(s) that can be used to change any/all settings stored about the cloud printer in cloud facsimile server 102.

3. Shared Users: A set of users, represented by service account identifiers or other suitable data that can be granted access to a specific printer. Wild-card characters can be allowed. This role/list can represent a white list or other suitable data. For public printers, this role/list can indicate all (with the wild-card representation being *).

a. Trusted: A shared user who is trusted to make use of more services/capabilities of the printer.

b. General Shared: Users with whom only certain capabilities of the printer are shared.

4. Blocked Users: This role/list can be a black list or other suitable blocked users, and can contain one or more specific entries, wild-card entries (*company.com), rules or other suitable data. The use of Wild-cards and rules can help to significantly reduce the database-intensive nature of maintaining black lists and convert the complexity into a more manageable computational complexity on demand.

Cloud printer 120A through 120N can provide capabilities and the various settings that it can be configured with for one or more associated print jobs. In one exemplary embodiment, an office inkjet printer can support several different print media, such as plain paper, company letter head and envelopes, and all of those media can be loaded into the different trays in the printer. Because fax jobs are usually printed on plain paper and not on company letter head or envelopes, cloud facsimile server 102 can allow the sender to choose the print media and even the print quality (such a draft mode to use less ink than normal or highest resolution modes of printing), the administrator(s) of the cloud printer can choose a subset of the printer capabilities to advertise for users from a given list or role, or other suitable controls can be provided. For example, a cloud printer may be capable of photo printing or other printing services or media, but users in a “General Shared Users” list can be blocked from using anything other than plain paper. However, users in a “Trusted Shared Users” list can be allowed to see and select available media types.

Other suitable restrictions, such as a maximum number of pages that can be printed to a machine, can also be enforced through these restrictions, such that after a print-job is submitted, cloud facsimile server 102 can return an error to the sender indicating that the user has exceeded the page limit set by the administrator of the printer, or other suitable errors.

Cloud facsimile server 102 can also provide a directory service that can be used to identify printer ID of a printer(s) based on the name, address, location or other data for the company, offices within the company (human resources, marketing, engineering), or other suitable data, so as to allow a cloud-based fax to be sent to an appropriate printers if a user does not know the specific printer ID number.

A printer administrator can also designate a printer to be a public printer. When this occurs, cloud facsimile server 102 can use a manual verification process to determine that the printer is being operated by the same company that the printer administrator claims is operating it, such as to prevent the inadvertent misidentification of a different company's printer. The printer administrator can likewise remove a printer from the directory if the printer has initially been verified for that administrator.

The directory service can also contain additional information that describes the company, its location, the type of business that it does or other suitable information, to allow a user to search by type of business, to verify that a recipient is correct or to perform other suitable functions. Private printers can be excluded from this directory, and a public printer that was added to the directory can be removed from the directory when it is either deleted or when it becomes a private printer.

A cloud printing client can be a cloud printing device that can send a digital facsimile or other suitable devices, such as a cloud connected scanners or cloud connected MFP. Cloud-connected MFPs are also likely to be cloud connected printers that can receive a digital facsimile. The scanning device of a sender can be authenticated with cloud facsimile server 102 based on the authorization provided by the sender for the sender's service account. In this exemplary embodiment, the scanning device can send print jobs to the following devices:

1. Cloud Printers owned by a sender's service account.
2. Cloud Printers shared with the sender's service account.
3. Cloud Printers found through the directory service based on the information that the user searches with.
4. Virtual Cloud Printers that act as a fax proxy to send to other services including PSTN fax:
a. If these printers are chosen, then one or more phone numbers can be provided so that the Virtual Cloud Printer can send the pages as a traditional fax to those phone numbers

It is not required that a directory service be used to obtain information about printer IDs of companies. If the recipient Company chooses not to make the printer a public printer, then the sender can request explicit authorization to use the recipient's printer by filling out an online form, after which the recipient can choose to share the printer with the sender. Subsequently, the sender can send the facsimile (and other print jobs) to the company through the printer that has been shared with the sender's service account.

The workflow of scanning and sending a print job to a cloud printer initiates secure submission of a document composed of one or more pages. Cloud facsimile server 102 notifies a receiver (the printer) of a new print job that has been submitted for printing, to enable the receiver to immediately initiate the receiving of the print job and printing it. Cloud facsimile server 102 also notifies the sender (the scanning device) of the job's status changes. When the confirmation of the successful printing of the job is reported, the sender can notify the user, either by printing a confirmation page if it is an MFP, by using a user interface notification, by sending an email or SMS message depending upon the capability of the machine, or in other suitable manners. Such a system ensures real-time facsimile like workflow.

Because the outgoing facsimile can be treated like a print job, the print settings that are applied can be indicated as the default settings of the printer for the role assigned by the receiving printer's administrator. If no specific print settings have been provided by sender, then cloud facsimile server 102 can substitute the empty print settings with the default settings that are defined by the receiving printer's administrator, such as based on the role or list that the submitter is part of or other suitable data.

In one exemplary embodiment, cloud facsimile server 102 can allow the submission request to specify multiple recipients in a single request, such that the image data is transmitted to cloud facsimile server 102 only once. This exemplary embodiment allows a sender to easily broadcast the same scanned content to multiple recipients. If cloud facsimile server 102 is not configured to allow a user to send a print job to multiple printers in a single submission request, then the sender can alternatively scan the document once and store the scanned document in an internal storage medium, a cloud based storage medium or other suitable locations, and then submit multiple requests to cloud facsimile server 102 with the data either being sent multiple times (once for each recipient), can be identified by a unique file identifier provided by a cloud based storage medium, or can be identified in other suitable manners.

As discussed above, a cloud-based fax system can interact with a traditional PSTN based fax system through a fax proxy, which can be implemented as a virtual cloud printer that is either explicitly shared with the user after the user signs up for service with the fax proxy service provider, which can be added to all users of the cloud printing system by default, or which can be provided in other suitable manners. The fax proxy can have at least two roles:

1. Virtual cloud printer, when receiving a facsimile job from a cloud connected scanning device and sending it to PSTN/VoIP based traditional fax.

2. Cloud Printing Client, when receiving a facsimile job from the PSTN/VoIP based traditional fax machine and forwarding it to a cloud connected printing device

One or more PSTN/VoIP destinations can be provided to the fax proxy. The fax proxy can send these jobs out to the provided telephone numbers through a multiple port in its outbound PSTN/VoIP system, by sending faxes to each of the recipient phone number given to it one-by-one, or in other suitable manners. The fax proxy can mark these jobs as completed successfully when the pages are successfully transferred to the recipients. The fax proxy service provider can maintain a log of all attempts to connect and connection duration and call rates for billing purposes. The administrator can configure the image settings (such as darker/lighter, maximum outbound fax image quality) on a job-by-job basis, through a control panel provided by the fax proxy service provider for the service account, or in other suitable manners.

One advantage of the present disclosure is that the use of all-digital communication ensures that no extra hardware/chipset is needed or required. There are also fewer electromagnetic interference issues to worry about because traditional fax circuits/chips and isolation circuits are not used, which lowers product cost and increases profitability. In addition, digital encryption can be used for communication between various entities, which can provide very secure end-to-end data transmission with no susceptibility to eavesdropping and other hacking mechanisms.

Cloud facsimile server 102 can also provide the status of the printer, which allows the sender to determine whether the receiving printer has been turned-on. In this exemplary embodiment, the receiving party can be contacted to turn on the printer or a different printer can be selected, which helps with urgent transmission of information.

Depending upon the implementation in the receiving cloud printer, the sending device will not only know the fact that the print job had problems printing but may also know what may be preventing the image data from being printed properly. This information can allow the parties to troubleshoot problems better.

Spam has been a big problem in traditional PSTN based fax. Since access control to the receiver is controlled by the receiver itself, it can choose to control who is allowed to send print jobs. This control allows spam to be inherently prevented by the system, as the entire communication happens in an authenticated environment with sufficient access control in place. The IP address and the cloud printing service account of spammers can also be posted to the system, which can block such users, or can be provided to all printers, which can block such users.

Printer abuse can also be prevented and consumption of printer supplies can be controlled by assigning the print capabilities exposed to a user based on a given role assigned by one of the printer administrators. Cloud facsimile server 102 can also be configured to buffer a fax job so that the sender can submit the fax even when the printer is powered-off. The recipient cloud printer can print the buffered jobs when the printer connects to the cloud printing service again, which allows the sender and the receiver to operate equipment at a time that is convenient to them.

The directory service and the process involved in maintaining the directory minimizes the possibility that an imposter would be able to gain access to information being transmitted. There are also no phone line charges to worry about, at least for users that are not using traditional fax machines. Quick broadcasts are also possible, because the Internet and other networked media offers superior bandwidth compared to the signaling operated by fax over the PSTN. This improves productivity of the sender.

When a fax proxy service is used, there is a likelihood of lower phone charges as compared to traditional PSTN fax service, as the proxy can make use of phone ports in local regions. The online status and history of fax jobs sent/received is likewise available.

Facsimile transmitter system 112 and facsimile receiver system 114 are coupled to cloud facsimile server 102 over communications medium 116, which can be the Internet, a public or private network, a wireless or wireline network, other suitable communications media or a suitable combination of communications media. User device 110 is coupled to cloud facsimile server 102 over wireless communications medium 118, which can be a 4G wireless network, the Internet, a public or private network, a wireless or wireline network, other suitable communications media or a suitable combination of communications media. Cloud printers 120A through 120N are coupled to communications medium 116, and can be controlled using facsimile receiver 114, cloud facsimile server 102, or other suitable systems.

Facsimile transmitter system 112 can generate facsimile data, such as by scanning a document using a scanning device, by converting a document from a document format, an image format, or other suitable formats into a facsimile format, or in other suitable manners. In one exemplary embodiment, facsimile transmitter system 112 can be registered with cloud facsimile server 102 to allow it to be a recognized facsimile transmitter device, which can allow a user to send faxes from facsimile transmitter system 112 to predetermined facsimile receiver systems 114, such as by using a rules-based blacklist control that prevents non-registered transmitters from accessing a facsimile receiver systems 114 or associated cloud printers 120A through 120N.

Facsimile receiver system 114 is configured to receive facsimile data from cloud facsimile server 102, such as files of facsimile data, facsimile data transmitted in accordance with a predetermined protocol or other suitable data. Facsimile receiver system 114 can include a printing device, can control cloud printers 120A through 120N, or can perform other suitable functions.

User device 110 allows a user to access facsimiles on cloud facsimile server 102, to transmit facsimiles to cloud facsimile server 102, and to perform other suitable functions.

In one exemplary embodiment, user device 110 can be configured to be used as a facsimile transmitter system 112 or a facsimile receiver system 114 in conjunction with cloud facsimile server 102, such as by allowing a user to select a facsimile receiver system 114 from an address book service or geolocator service of cloud facsimile server 102, to transmit emails, texts, documents, images or other suitable data to a facsimile receiver system 114, to access stored received faxes associated with a user account, and for other suitable purposes.

In operation, system 100 allows a user to transmit and receive facsimiles over a cloud facsimile service. A user can transmit a facsimile or other suitable data from facsimile transmitter system 112 to cloud facsimile server 102, which then transmits the facsimile to a facsimile receiver system 114, which can be a PSTN facsimile receiver (such as by using a PSTN data connection), a cloud-based printing server or other suitable devices. A user can likewise receive a facsimile at facsimile receiver system 114 from cloud facsimile server 102, such as from a wireless device, a PSTN facsimile transmitter (through a PSTN data connection to cloud facsimile server 102), and can obtain additional information regarding the sender of the facsimile, to access the facsimile from suitable device, or in other suitable manners.

FIG. 2 is a diagram of a system 200 for access control to a cloud facsimile service in accordance with exemplary embodiment of the present disclosure. System 200 includes cloud facsimile access controls 104 and private printer control 202, cloud printer settings 204, approved public printer controls 206 and the cloud filter control 208, each of which can be implemented in hardware or suitable combination of hardware and software, and which can be one or more software systems operating on one or more processors.

Private printer control 202 generates one or more user controls to allow a user to access a facsimile receiver system 114, cloud printers 120A through 120N or other suitable devices that are not accessible to the public, such as by requesting access, by entering a password or in other suitable manners. In this exemplary embodiment, a separate user account can be used to provide access to facsimile transmitter system 112, such as by requiring a user to sign on before being able to scan in or send a facsimile or in other suitable manners.

Cloud printer settings 204 generates one or more user controls to user to identify parties that are allowed to access cloud printer servers, devices that are allowed to access facsimile receiver system 114 or a cloud-based printer or printer server, devices that are restricted from accessing facsimile receiver system 114 or a cloud-based printer or printer server, or other suitable filters. In this exemplary embodiment, cloud printer settings 204 can be used to prevent abusive facsimile practices, such as spamming or mass facsimile transmissions to parties that are not interested in receiving the faxed message.

Approved public printer control 206 allows a user, administrator, or other suitable persons to identify an approved public printer for access to members of the public. In one exemplary embodiment, an administrator for a printer can register the printer for use as an approved public printer, and can provide contact information, location information, information for use in an address book, information for use in a geolocator service or other suitable data. After subsequent manual confirmation, the approved public printer control 206 can be used to provide printer identification information to a directory or other suitable locations.

Cloud filter control 208 generates one or more controls that allow a user to configure one or more filters to prevent spam, abuse of facsimile receiver system 114 and cloud printers 120A through 120N or other problems. In one exemplary embodiment, a suitable identification field for a cloud facsimile account can be identified, such as to identify accounts that have been recently opened, accounts associated with an Internet service provider that has a history of providing spam, accounts associated with a physical location that has a history of spam activities, or other suitable data. Likewise, cloud filter control 208 can be used to authorize predetermined acceptable users, such as those having IP addresses that are known valid IP addresses, account data that has been verified, or other suitable cloud filters.

In operation, system 200 allows access controls to be generated that allow user, an administrator, or other suitable personnel to configure a cloud facsimile service. In this manner, system 200 provides novel user control interfaces with predetermined functionality for use with cloud facsimile server 102 or other suitable cloud facsimile services.

FIG. 3 is a diagram of a system 300 for providing cloud-based facsimile service transmit controls, in accordance with an exemplary embodiment of the present disclosure. System 300 includes class facsimile transmit controls 106 and job completion report system 302, cloud printer control 304, facsimile proxy control 306, geolocation control 308, address book control 310, and alternate notification control 312, each of which can be implemented in hardware or a suitable combination of hardware and software, and which can be one or more software systems operating on one or more processors.

Job completion report system 302 generates one or more controls that allow a user to configure a job completion report. In one exemplary embodiment, job completion report parameters can be configured for a transmit device, a receiver device or other suitable devices. In this exemplary embodiment, a transmit device can be configured to receive all relevant job completion date if it is a PC-based transmitter device, such as the time at which a fax was printed, the number of pages, whether there were any errors and other suitable data. Likewise, a receiver device can be configured to generate job completion data and store the data in a file, to send the data over a fax communications channel, to send a separate fax after a file has been remotely accessed or other suitable job completion data.

Cloud printer control 304 generates one or more user controls that allow a user to set printer controls at a receiving device. In one exemplary embodiment, a user that is configuring a fax for transmission can be presented with printer controls, such as to select a media type, a print quality, or other suitable controls. The generation of cloud printer controls for user can be a function of the user's access rights to the receiver device, a user's position within an organization, or other suitable variables.

Facsimile proxy control 306 generates one or more user controls that allow a user to configure transmit devices for interfacing with PSTN fax machines. In one exemplary embodiment, a cloud facsimile service can interface with PSTN-based fax machine through a proxy, such as a system that interfaces with the PSTN and which sends fax data to and receives data from PSTN-based fax machines. Because such PSTN-based fax machines have a limited ability to receive data from and to provide data to a cloud-based transmitting device, facsimile proxy control 306 allows the user to configure the transmitter to send predetermined data fields to PSTN-based fax machines and to receive data fields from the PSTN-based fax machines, as well as to perform other suitable functions for such fax machines (such as to resend the fax if it has not been received).

Geolocation control 308 allows the user to identify fax machines based on physical location. In one exemplary embodiment, geolocation control 308 can be used to search for a facsimile receiver based on a physical location, to identify a physical location associated with a selected facsimile receiver or to perform other geolocation services to allow the user to confirm an intended receiver.

Address book control 310 allows the user to find a receiver fax machine based on one more address parameters. In one exemplary embodiment, a user can look up a receiver fax machine using one or more of an organization's name, an associated department within an organization, an employee name, an employee function or other suitable address parameters. Likewise, address book control 310 can limit the data that is provided to a user based on an authorization level of the user, so as to limit the amount of information or location of receiver fax machines that are provided to members of the public, to limit internal fax machine addresses to members of an organization or for other suitable purposes.

Alternate notification control 312 generates one or more user controls that allow a user to configure alternate notification processes for a device, facsimile message, or other suitable data. In one exemplary embodiment, a user can request notification when a facsimile has been viewed, such that printing or otherwise providing a time at which the facsimile was viewed maybe impractical. In this exemplary embodiment, a user can be prompted to provide a text address, an email address, or other suitable alternate means of notification, and when a message is viewed, the user can receive notification over the provided communications channel. In another exemplary embodiment, a user can request notification when a fax has been received, such as to allow the user to log onto the user's account using a mobile device or in other suitable manners.

In operation, system 300 provides a plurality of user controls for a facsimile transmitter device in a cloud facsimile system that allows the user to configure the transmitter device, to select receiver devices and to perform other suitable functions.

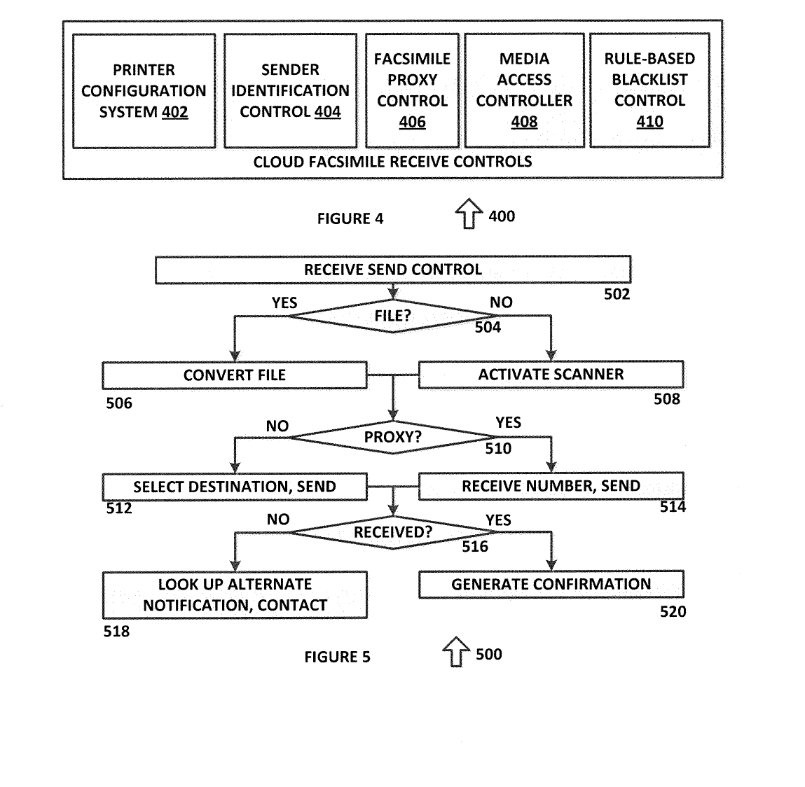

FIG. 4 is a diagram of a system 400 for generating cloud facsimile receiver controls in accordance with an exemplary embodiment of the present disclosure. System 400 includes cloud facsimile receiver controls 108 and printer configuration system 402, sender identification control 404, facsimile proxy control 406, media access control 408 and rule-based blacklist control 410, each of which can be implemented in hardware or a suitable combination of hardware and software, and which can be one or more software systems operating on one or more processors.

Printer configuration system 402 generates one or more user controls that allow an administrator or other user to control one or more printers associated with a facsimile receiver. In one exemplary embodiment, different printers can be assigned to different incoming faxes for printing, such as based on a recipient identifier, a media type, a source address or other suitable data. In another example embodiment, a default printer can be identified and back-up printers can be identified for use when the default printer is unavailable. Likewise, other suitable printer configurations to be implemented.

Sender identification control 404 generates one or more user controls that allow an administrator or other user to identify the types of data to be requested from a sender, to put restrictions on senders, to approve senders, or to perform other suitable functions. In one exemplary embodiment, sender notification control 404 can allow a sender to be queried for additional information before access is approved, such as by requesting prompting the sender to enter a password, by prompting an administrator to approve the sender, or in other suitable manners.

Facsimile proxy control 406 generates one or more user controls that allow a user to configure a receiver device to receive faxes from a PSTN-based fax machine. In one exemplary embodiment, facsimile proxy control 406 can be used to block facsimiles from PSTN-based fax machines, can be used to set filters for such faxes based on caller identification data or area code data, or other suitable controls can be provided.

Media access controller 408 generates one or more user controls that allow an administrator or the user to control access to available print media. In one exemplary embodiment, a control can be generated to limit faxes sent to a public fax address to predetermined media, such as plain paper, a control can be generated to limit predetermined faxes to selected print quality, such as the lowest quality, or other suitable controls can be provided. Likewise, authorized users can be allowed to access other suitable printing services, such as color printers, photo printers, letterhead or envelope printers, or other suitable printers.

Rule-based blacklist control 410 generates one or more user controls that allow an administrator or other suitable users to generate rules for controlling access to a fax machine or cloud printer. In one exemplary embodiment, the rule-based blacklist controls can prevent users that have pretty predetermined email extensions, predetermined IP addresses, predetermined countries of origin, or other suitable data from accessing a printer or fax machine, such as to prevent spamming or other abuse. In another exemplary embodiment, user account data such as creation time, a number of complaints received from third parties, a number of faxes sent within a predetermined time or other suitable data can be used to block users, block receipt of faxes, or to otherwise prevent the users from sending a fax.

In operation, system 400 allows a user to configure controls for a fax machine or cloud-based printer for a cloud facsimile service. System 400 allows one or more controls to be generated to control the use of resources, to prevent spamming and abuse and for other suitable functions.

FIG. 5 is a diagram of an algorithm of 500 for configuring cloud-based facsimile service access, access to facsimile transmitters, and access to facsimile receivers in accordance with an exemplary embodiment of the present disclosure. Algorithm 500 can be implemented in hardware or a suitable combination of hardware and software, and can be one or more software systems operating on one more processors.

Algorithm 500 begins at 502, where a send control is received. The algorithm then proceeds to 504, where it is determined whether the send control is associated with a file, such as by reading header data of a transmission packet and by determining whether the header data identifies a file or a data stream using a processor or other suitable data processing equipment or circuits. If it is determined at 504 that a file has been received, the algorithm proceeds to 506 where the file is converted into a suitable format, such as a format that is compatible with a facsimile transmission protocol. Likewise, if it is determined at 504 that a file has not been received, the algorithm proceeds 508, where a scanner is activated. The scanner then generates one or more sets of image data and the algorithm proceeds to 510.

At 510, it is determined whether a proxy device has been identified to receive the facsimile data. If it is determined that a proxy device is not being used, the algorithm proceeds to 512, where a destination device is selected, such as using an address book, by entering a destination address, by using a geolocation service or in other suitable manners. The facsimile is then sent and the algorithm proceeds to 516. If it is determined at 510 that a proxy device is going to receive the fax data, the algorithm proceeds to 514 where a phone number for the proxy device is received and is used to send the facsimile data, such as by transmitting the phone number to a cloud facsimile server 102, by dialing the number over the PSTN and then by sending the fax data over the PSTN using a PSTN fax transmission protocol. The algorithm then proceeds to 516.

At 516, it is determined whether a facsimile has been received, such as by waiting for the receipt of data from the fax transmission receiver machine, by monitoring one or more buffers for predetermined data or in other suitable manners. If it is determined that the facsimile has not been received, the algorithm proceeds to 518, where an alternate notification process is performed. In one exemplary embodiment, a recipient can be notified by text, email, a phone call or by using other suitable processes to alert them regarding the received a facsimile message. Otherwise, if it is determined at 516 that the facsimile has been received, the algorithm proceeds to 520. At 520, a confirmation is generated, such as by storing data in a user account to identify that the fax was received at a cloud fax receiver, by sending an email or text message, by printing, or in other suitable manners.

In operation, algorithm 500 allows users to send and receive facsimiles using a cloud-based facsimile service. Algorithm 500 allows users to receive facsimile data, to access facsimiles from cell phones or other suitable devices, and for other suitable functions.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for cloud-based facsimile services comprising:
a facsimile transmitter system configured to generate image data of a document and to transmit the image data over a network;
a facsimile receiver system configured to receive the image data and to generate image status data over the network; and
a cloud facsimile server configured to receive the image data from the facsimile transmitter system, to process the image data as a function of sender data and recipient data, to transmit the image data to the facsimile receiver system, to receive the image status data from the facsimile receiver system and to transmit the image status data to the facsimile transmitter system.

2. The system of claim 1 further comprising a facsimile proxy service configured to receive the image data from the cloud facsimile service and to transmit the image data over a Public switched telephone network to a facsimile device.

3. The system of claim 1 further comprising a private printer control configured to generate one or more user-selectable controls to allow a user to designate one or more users that are permitted to access a private printer through the cloud facsimile server.

4. The system of claim 1 further comprising a cloud printer setting control configured to generate one or more user-selectable controls to allow a user to designate one or more cloud printer settings and to store the cloud printer settings at the cloud facsimile server.

5. The system of claim 1 further comprising an approved public printer control configured to receive printer data and an associated user-entered control to designate a printer for public use and to generate a flag requiring an operator to manually confirm the printer data.

6. The system of claim 1 further comprising a geolocation control configured to receive geolocation data from a user and to return two or more facsimile receiver systems associated with a cloud facsimile server and the geolocation data that can receive a facsimile message.

7. The system of claim 1 further comprising an address book control configured to receive address data from a user and to return two or more facsimile receiver systems associated with a cloud facsimile server and the address data that can receive a facsimile message.

8. The system of claim 1 further comprising a rule-based blacklist control configured to receive rule data defining one or more account variables for preventing access to a facsimile receiver system of a cloud facsimile server.

9. The system of claim 1 further comprising a facsimile proxy control configured to receive control data from a user to configure a facsimile transmitter system to interface with a PSTN-based facsimile device through a cloud facsimile server.

10. A method for cloud-based facsimile services comprising:
generating image data of a document at a facsimile transmitter system;
transmitting the image data over a network;
receiving the image data at a cloud facsimile server;
processing the image data as a function of sender data and recipient data;
transmitting the image data to a facsimile receiver system;
receiving image status data from the facsimile receiver system; and
transmitting the image status data to the facsimile transmitter system.

11. The method of claim 10 further comprising:
receiving the image data from the cloud facsimile service; and
transmitting the image data over a public switched telephone network to a facsimile device.

12. The method of claim 10 further comprising generating one or more user-selectable controls to allow a user to designate one or more users that are permitted to access a private printer through the cloud facsimile server.

13. The method of claim 10 further comprising:
generating one or more user-selectable controls to allow a user to designate one or more cloud printer settings; and
storing the cloud printer settings at the cloud facsimile server.

14. The method of claim 10 further comprising:
receiving printer data and an associated user-entered control to designate a printer for public use; and
generating a flag requiring an operator to manually confirm the printer data.

15. The method of claim 10 further comprising:
receiving geolocation data from a user; and
returning to the user identifiers of two or more facsimile receiver systems associated with a cloud facsimile server and the geolocation data that can receive a facsimile message.

16. The method of claim 10 further comprising:
receiving address data from a user; and
returning to the user identifiers of two or more facsimile receiver systems associated with a cloud facsimile server and the address data that can receive a facsimile message.

17. The method of claim 10 further comprising:
receiving rule data defining one or more account variables for preventing access to a facsimile receiver system of a cloud facsimile server; and
applying the rule data to prohibit access to the facsimile receiver system.

18. The method of claim 10 further comprising:
receiving control data from a user to configure a facsimile transmitter system to interface with a public switched telephone network (PSTN)-based facsimile device through a cloud facsimile server; and
using the cloud facsimile server to transmit a facsimile message to the PSTN-based facsimile device.

19. In a system for cloud-based facsimile services that includes a facsimile transmitter system configured to generate image data of a document and to transmit the image data over a network, a facsimile receiver system configured to receive the image data and to generate image status data over the network, a cloud facsimile server configured to receive the image data from the facsimile transmitter system, to process the image data as a function of sender data and recipient data, to transmit the image data to the facsimile receiver system, to receive the image status data from the facsimile receiver system and to transmit the image status data to the facsimile transmitter system, a facsimile proxy service configured to receive the image data from the cloud facsimile service and to transmit the image data over a Public switched telephone network to a facsimile device, a private printer control configured to generate one or more user-selectable controls to allow a user to designate one or more users that are permitted to access a private printer through the cloud facsimile server, a cloud printer setting control configured to generate one or more user-selectable controls to allow a user to designate one or more cloud printer settings and to store the cloud printer settings at the cloud facsimile server, an approved public printer control configured to receive printer data and an associated user-entered control to designate a printer for public use and to generate a flag requiring an operator to manually confirm the printer data, a geolocation control configured to receive geolocation data from a user and to return two or more facsimile receiver systems associated with a cloud facsimile server and the geolocation data that can receive a facsimile message, an address book control configured to receive address data from a user and to return two or more facsimile receiver systems associated with a cloud facsimile server and the address data that can receive a facsimile message, a rule-based blacklist control configured to receive rule data defining one or more account variables for preventing access to a facsimile receiver system of a cloud facsimile server, and a facsimile proxy control configured to receive control data from a user to configure a facsimile transmitter system to interface with a PSTN-based facsimile device through a cloud facsimile server, a method comprising:
generating image data of a document at a facsimile transmitter system;
transmitting the image data over a network;
receiving the image data at a cloud facsimile server;
processing the image data as a function of sender data and recipient data;
transmitting the image data to a facsimile receiver system;
receiving image status data from the facsimile receiver system;
transmitting the image status data to the facsimile transmitter system;
receiving the image data from the cloud facsimile service;
transmitting the image data over a public switched telephone network to a facsimile device;
generating one or more user-selectable controls to allow a user to designate one or more users that are permitted to access a private printer through the cloud facsimile server;
generating one or more user-selectable controls to allow a user to designate one or more cloud printer settings;
storing the cloud printer settings at the cloud facsimile server;
receiving printer data and an associated user-entered control to designate a printer for public use;
generating a flag requiring an operator to manually confirm the printer data;
receiving geolocation data from a user;
returning to the user identifiers of two or more facsimile receiver systems associated with a cloud facsimile server and the geolocation data that can receive a facsimile message;
receiving address data from a user;
returning to the user identifiers of two or more facsimile receiver systems associated with a cloud facsimile server and the address data that can receive a facsimile message;
receiving rule data defining one or more account variables for preventing access to a facsimile receiver system of a cloud facsimile server;
applying the rule data to prohibit access to the facsimile receiver system;
receiving control data from a user to configure a facsimile transmitter system to interface with a public switched telephone network (PSTN)-based facsimile device through a cloud facsimile server; and
using the cloud facsimile server to transmit a facsimile message to the PSTN-based facsimile device.
